(19) United States
(12) Patent Application Publication
(10) Pub. No.: US 2011/0129109 A1
(43) Pub. Date: Jun. 2, 2011

(54) ELECTRONIC DEVICE

(75) Inventor: Isao Okutsu, Hamura-shi (JP)

(73) Assignee: Kabushiki Kaisha Toshiba, Tokyo (JP)

(21) Appl. No.: 12/949,635

(22) Filed: Nov. 18, 2010

(30) Foreign Application Priority Data
Dec. 2, 2009 (JP) 2009-274710

(51) Int. Cl. H04R 1/02

(52) U.S. Cl. 381/332

(57) ABSTRACT

According to one embodiment, an electronic device includes a main body and a speaker unit. The main body includes a housing and an electronic component. The speaker unit includes a speaker main body and a speaker cabinet to which the speaker main body is attached. The speaker cabinet can be housed in the housing and protrude out of the housing. The inner volume of the speaker cabinet is variable.

### CROSS-REFERENCE TO RELATED APPLICATIONS

This application is based upon and claims the benefit of priority from Japanese Patent Application No. 2009-274710, filed Dec. 2, 2009, the entire contents of which are incorporated herein by reference.

### FIELD

Embodiments described herein relate generally to an electronic device.

### BACKGROUND

For example, Japanese Patent Application Publication (KOKAI) No. 2003-323230 discloses a conventional technology related to an electronic device, such as a notebook personal computer, provided with a speaker having a cabinet that can be folded and unfolded in an accordion-like manner.

With the conventional technology, the speaker is externally attached to the housing of the electronic device, and expands when the cabinet is unfolded. This increases the size of the electronic device as a whole.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view of an electronic device according to a first embodiment;

FIG. 2 is an exemplary side view of the electronic device in the closed position illustrating the state where the end divisional portion of a speaker unit is housed in the first embodiment;

FIG. 3 is an exemplary side view of the electronic device in the open position illustrating the state where the end divisional portion of the speaker unit protrudes in the first embodiment;

FIG. 4 is an exemplary perspective view of the speaker unit in the first embodiment;

FIG. 5 is an exemplary vertical cross-sectional view of the speaker unit in the housed state in the first embodiment;

FIG. 6 is an exemplary vertical cross-sectional view of the speaker unit in the protruding state in the first embodiment;

FIG. 7 is an exemplary perspective view of a speaker unit, a hinge mechanism, and an interlocking mechanism of an electronic device in the closed position illustrating the state where the end divisional portion of the speaker unit is housed according to a second embodiment;

FIG. 8 is an exemplary perspective view of the speaker unit, the hinge mechanism, and the interlocking mechanism of the electronic device in the open position illustrating the state where the end divisional portion of the speaker unit protrudes according in the second embodiment;

FIG. 9 is an exemplary vertical cross-sectional view of a speaker unit of an electronic device illustrating the state where the end divisional portion of the speaker unit is housed according to a third embodiment;

FIG. 10 is an exemplary vertical cross-sectional view of the speaker unit illustrating the state where the end divisional portion of the speaker unit protrudes in the third embodiment;

FIG. 11 is an exemplary vertical cross-sectional view of an electronic device illustrating the state where the end divisional portion of a speaker unit is housed according to a fourth embodiment;

FIG. 12 is an exemplary vertical cross-sectional view of an electronic device illustrating the state where the end divisional portion of a speaker unit is housed according to a fifth embodiment; and

FIG. 13 is an exemplary side view of an electronic device in the open position illustrating the state where the end divisional portion of a speaker unit protrudes according to a sixth embodiment.

### DETAILED DESCRIPTION

In general, according to one embodiment, an electronic device comprises a main body and a speaker unit. The main body comprises a housing and an electronic component. The speaker unit comprises a speaker main body and a speaker cabinet to which the speaker main body is attached. The speaker cabinet is configured to be able to be housed in the housing and protrude out of the housing. The inner volume of the speaker cabinet is variable.

According to another embodiment, a speaker unit for an electronic device comprising a main body including a housing and an electronic component comprises a speaker main body and a speaker cabinet to which the speaker main body is attached. The speaker cabinet is configured to be able to be housed in the housing and protrude out of the housing. The inner volume of the speaker cabinet is variable.

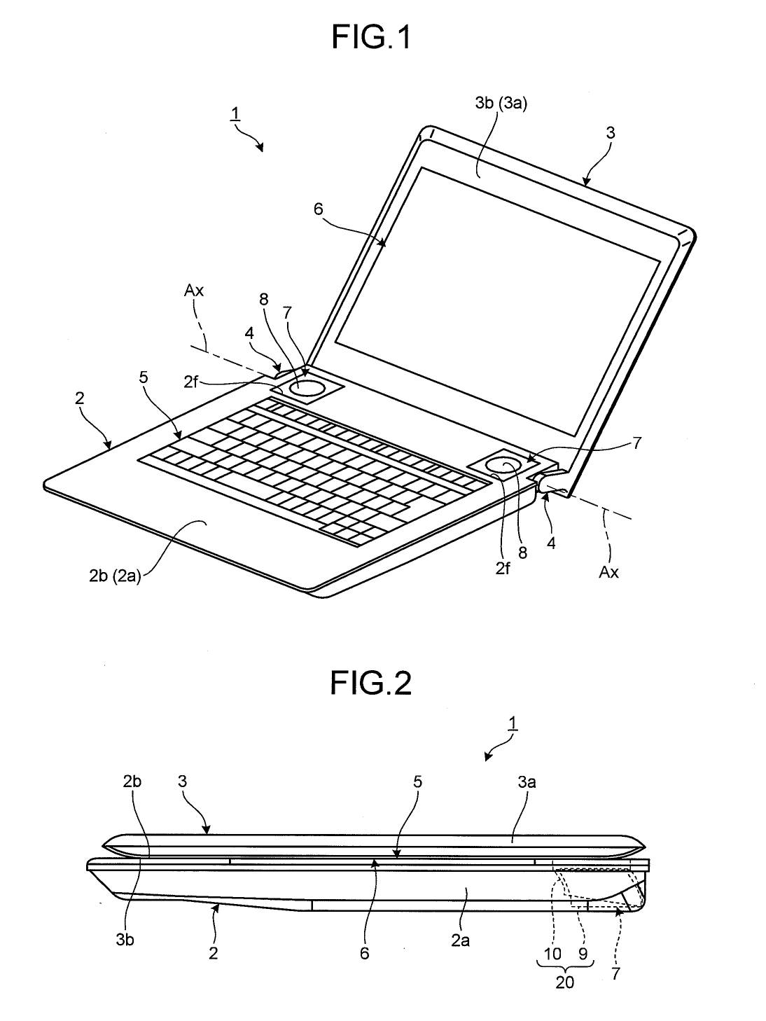

With reference to FIGS. 1 to 6, a description will be given of an electronic device 1 according to a first embodiment.

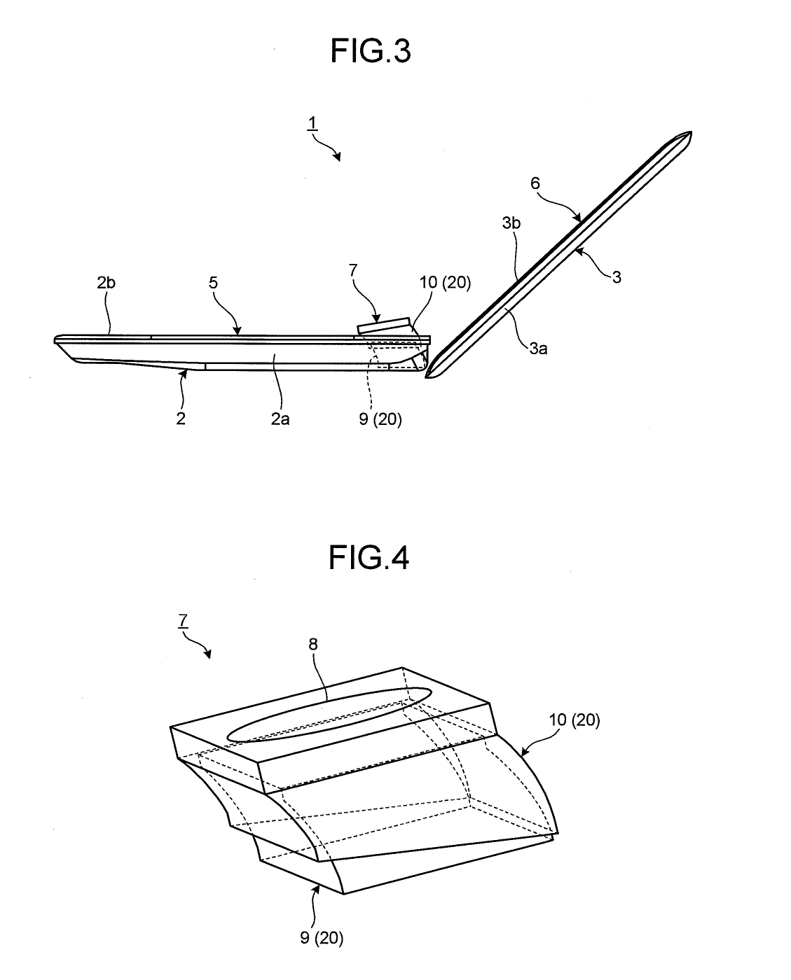

As illustrated in FIG. 1, the electronic device 1 of the first embodiment is, for example, a notebook personal computer. The electronic device 1 comprises a flat rectangular first body 2 and a flat rectangular second body 3. The first body 2 and the second body 3 are connected by a hinge mechanism 4 to be relatively rotatable about a rotation axis Ax between a closed position (FIG. 2) and an open position (FIG. 3).

The first body 2 comprises a housing 2a that houses a circuit board, a hard disk, a cooling fan, and the like. The circuit board is mounted with a central processing unit (CPU), a read only memory (ROM), a random access memory (RAM), and other electronic components (all not illustrated). The first body 2 is provided with a keyboard 5 as an input device on a front surface 2b. On the other hand, the second body 3 is provided with a liquid crystal display (LCD) panel 6 as a display device on a front surface 3b. When the first body 2 and the second body 3 are in the closed position, as illustrated in FIG. 2, the front surface 2b of the housing 2a of the first body 2 faces the front surface 3b of a housing 3a of the second body 3, and the keyboard 5 faces the LCD panel 6. On the other hand, in the open position, the front surfaces 2b and 3b are exposed as illustrated in FIG. 3, and the keyboard 5 and the LCD panel 6 are exposed to allow the user to use them. The keyboard 5 and the LCD panel 6 are electronic components.

As illustrated in FIG. 1, speaker units 7 are attached to the first body 2. The speaker units 7 are provided to two points at corners of the first body 2 on a side near the second body 3. Openings 2f are formed on the front surface 2b of the housing 2a. The speaker units 7 are housed in the housing 2a from the openings 2f, respectively.

As illustrated in FIGS. 2 and 3, the speaker unit 7 comprises a base divisional portion 9 fixed to the first body 2 and an end divisional portion 10 attached to the base divisional portion 9 to be slidable relative thereto. The end divisional portion 10 is housed in the housing 2a when the electronic device 1 is in the closed position as illustrated in FIG. 2 (housed state), while it protrudes out of the housing 2a (in the first embodiment, above the front surface 2b) when the electronic device 1 is in the open position as illustrated in FIG. 3 (protruding state). The user can manually pull up or push down the end divisional portion 10. When the first body 2 and the second body 3 move from the open position to the closed position, the second body 3 pushes the end divisional portion 10 into the housing 2a of the first body 2.

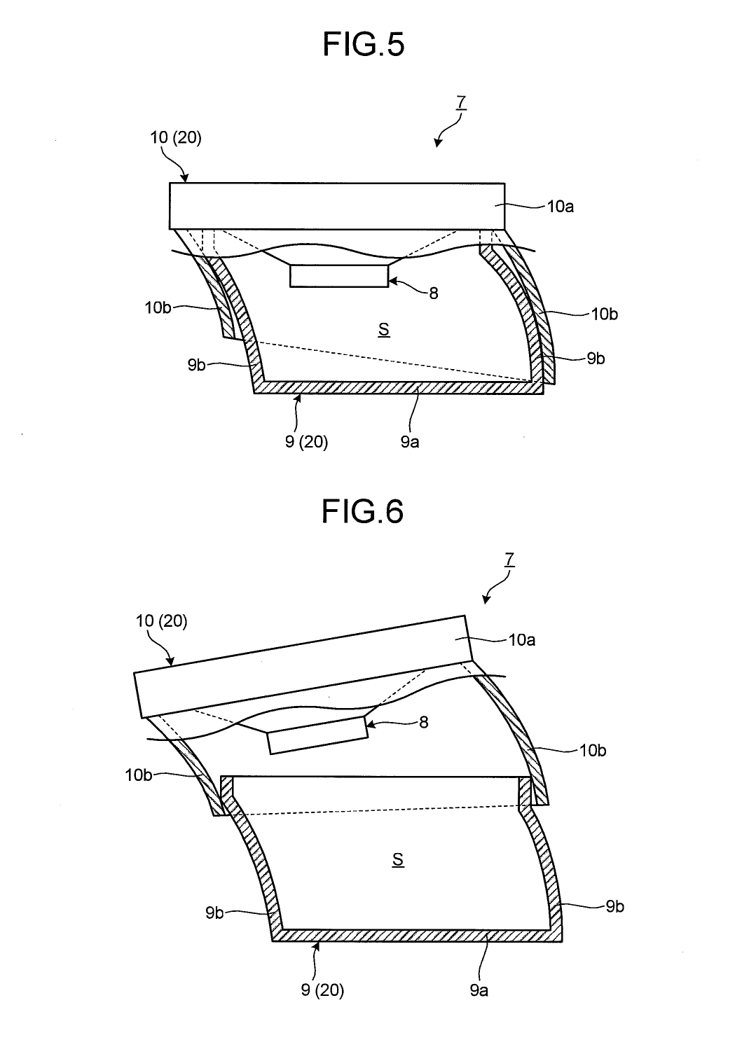

In the first embodiment, as illustrated in FIGS. 4 to 6, the base divisional portion 9 is a bottomed substantially rectangular cylindrical portion having an opening on the upper side (on the end side). The end divisional portion 10 is a bottomed substantially rectangular cylindrical portion having an opening on the lower side (on the base side). In the housed state illustrated in FIG. 5, a circumference wall 10b of the end divisional portion 10 surrounds outside a circumference wall 9b of the base divisional portion 9. The circumference walls 9b and 10b serve as guides for the relative movement of the base divisional portion 9 and the end divisional portion 10 between the housed state and the protruding state. In the protruding state illustrated in FIG. 6, the edge of the circumference wall 10b of the end divisional portion 10 on the opening side surrounds outside the edge of the circumference wall 9b of the base divisional portion 9 on the opening side. A bottom wall 9a of the base divisional portion 9 is fixed to the housing 2a of the first body 2. Attached to a bottom wall 10a of the end divisional portion 10 is a speaker main body 8 that outputs sound toward the outside of the end side.

The base divisional portion 9 and the end divisional portion 10 may be made of, for example, synthetic resin, metal material, or the like. The relative positions of the base divisional portion 9 and the end divisional portion 10 can be maintained by, for example, a frictional force generated with the elastic deformation of at least one of the circumference walls 9b and 10b. Accordingly, the end divisional portion 10 can be in a state between the housed state illustrated in FIG. 5 and the protruding state illustrated in FIG. 6 (half-protruding state). The relative positions can also be maintained by providing convexo-concave portions (not illustrated) to parts of the circumference walls 9b and 10b that face each other (i.e., the outer circumference surface and the inner circumference surface that face each other). That is, the relative positions can be maintained by the engagement of the convexo-concave portions. Besides, convexo-concave portions (not illustrated) may be provided to prevent the end divisional portion 10 from coming off the base divisional portion 9.

As can be seen from FIGS. 5 and 6, in the first embodiment, the base divisional portion 9 and the end divisional portion 10 constitute a speaker cabinet 20. With this, a sound chamber S is formed in the speaker unit 7. The sound chamber S is surrounded by the bottom walls 9a and 10a, and the circumference walls 9b and 10b. By variably setting the relative positions of the base divisional portion 9 and the end divisional portion 10, the volume of the sound chamber S (the inner volume of the speaker cabinet 20) can be set to a variable level to increase the sound quality. More specifically, in the protruding state illustrated in FIG. 6, the sound chamber S is larger than in the housed state illustrated in FIG. 5. Thus, the sound quality (for example, the quality of low-pitched sound) can be improved. The volume of the sound chamber S is variable and may be set to an appropriate level by adjusting the protruding amount of the end divisional portion 10 with respect to the base divisional portion 9 to achieve the desired sound quality. The speaker unit 7 need not necessarily be sealed, and may have an opening at an appropriate position.

As can be seen from FIGS. 3, 5, and 6, in the first embodiment, the end divisional portion 10 slides along a curve (curved path) in a direction separate from the LCD panel 6 as protruding with respect to the base divisional portion 9. With this, the direction in which the speaker main body 8 outputs sound becomes close to the use's ear, which increases the sensory sound volume.

As described above, according to the first embodiment, the speaker unit 7 comprises the speaker main body 8 and the speaker cabinet 20. The speaker main body 8 is attached to the speaker cabinet 20. The speaker cabinet 20 can be in the housed state in which it is housed in the housing 2a and also in the protruding state in which it protrudes out of the housing 2a. The inner volume of the speaker cabinet 20 is variable. The speaker cabinet 20 comprises the base divisional portion 9 and the end divisional portion 10 as a plurality of divisional portions. The base divisional portion 9 and the end divisional portion 10 are coupled with each other to be relatively slidable and can vary the inner volume of the speaker cabinet 20 (the volume of the sound chamber S). The end divisional portion 10 to which the speaker main body 8 is attached is housed in the housing 2a of the first body 2 in the housed state, while it protrudes out of the housing 2a in the protruding state. Thus, the speaker unit 7 is capable of increasing the sound quality by setting the volume of the sound chamber S to a variable level, and can be housed in the housing 2a of the first body 2 of the electronic device 1. This downsizes the electronic device 1 as a whole. Incidentally, in the housed state in which the speaker unit 7 is housed in the housing 2a, the speaker unit 7 need not be completely enclosed inside the housing 2a. If part of the speaker unit 7 is exposed out of the housing 2a as in the first embodiment, the speaker unit 7 is herein regarded as being in the housed state.

According to the first embodiment, the electronic device 1 comprises the first body 2 and the second body 3. The first body 2 is provided with the keyboard 5 as an input device, while the second body 3 is provided with the LCD panel 6 as a display device. The first body 2 and the second body 3 are connected by the hinge mechanism 4 to be relatively rotatable at least between the closed position (FIG. 2) and the open position (FIG. 3). The end divisional portion 10 is housed in the housing 2a in the closed position (housed state), while it protrudes out of the housing 2a in the open position (protruding state). Thus, when the electronic device 1 is in the open position and is being used by the user, the end divisional portion 10 protrudes out of the housing 2a, which increases the sound quality. On the other hand, when the electronic device 1 is in the closed position and is not being used, the end divisional portion 10 is housed in the housing 2a, which reduced the size of the electronic device 1.

According to the first embodiment, the end divisional portion 10 protrudes outward from the front surface 2b of the housing 2a of the first body 2 that faces the housing 3a of the second body 3. With this, when the second body 3 is moved relative to the first body 2 from the open position to the closed position, the front surface of the housing 3a of the second body 3, which faces the front surface 2b of the housing 2a, pushes down the protruding end divisional portion 10. Thus, the end divisional portion 10 can be housed in the housing 2a.

According to the first embodiment, the end divisional portion 10 slides along a curve (curved path) relative to the base divisional portion 9. This enables the posture (angle) of the speaker main body 8 attached to the end divisional portion 10 with respect to the housing 2a to change between the housed state and the protruding state. Thus, the speaker main body 8 can be easily set at a more suitable posture (angle) in the protruding state.

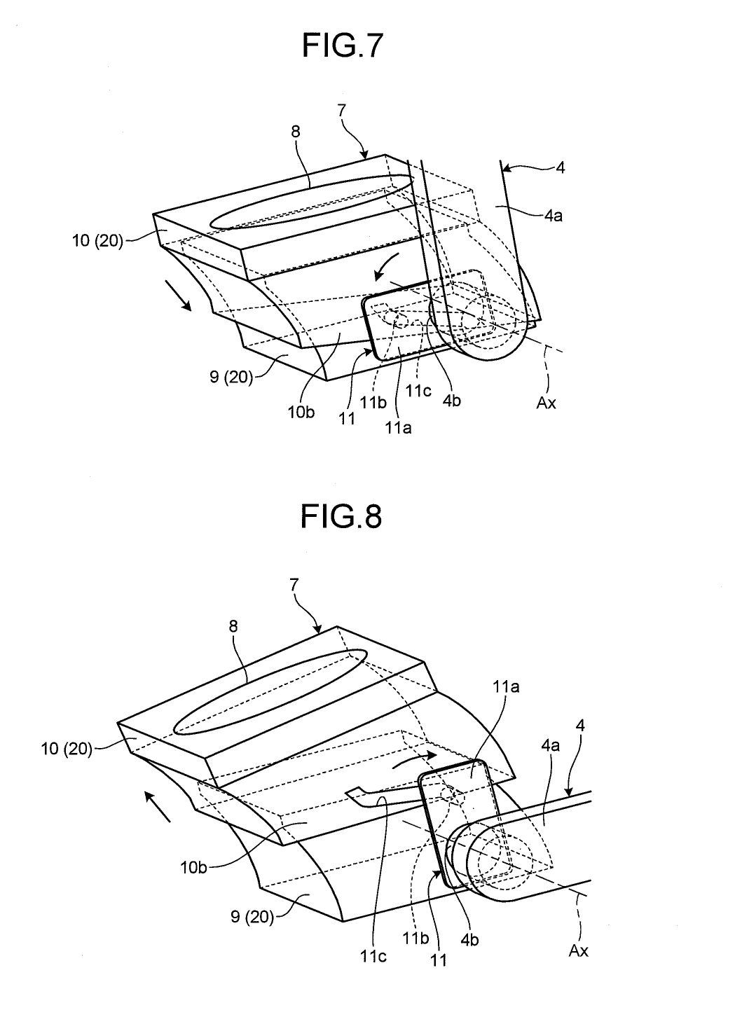

With reference to FIGS. 7 and 8, a description will be given of an electronic device according to a second embodiment.

In the second embodiment, an interlocking mechanism 11 is provided to move the end divisional portion 10 relative to the base divisional portion 9 in response to the relative rotation of the first body 2 and the second body 3 about the rotation axis Ax. More specifically, a shaft 4b is connected to the second body 3 through an arm 4a of the hinge mechanism 4 to be rotatable about the rotation axis Ax. A plate 11a as a moving member is fixed to the shaft 4b in parallel to part of the circumference wall 10b of the end divisional portion 10. The plate 11a is provided with a pin 11b as a slider that extends toward the circumference wall 10b. A groove 11c is formed in the circumference wall 10b as a guide rail for the pin 11b. The shaft 4b is rotatably supported by the housing 2a of the first body 2. With this, by setting the path of the groove 11c appropriately, the pin 11b relatively moves in the groove 11c along with the rotation of the shaft 4b and the plate 11a about the rotation axis Ax. The pin 11b pushes the periphery of the groove 11c, i.e., part of the circumference wall 10b, while relatively moving. In the example of FIGS. 7 and 8, having rotated counterclockwise, the plate 11a lays when the first body 2 and the second body 3 are in the closed position as illustrated in FIG. 7. At this time, the end divisional portion 10 is located on the base side (lower side of FIG. 7) with respect to the base divisional portion 9 according to the positional relation between the pin 11b and the groove 11c and is in the housed state. On the other hand, having rotated clockwise, the plate 11a stands when the first body 2 and the second body 3 are in the open position as illustrated in FIG. 8. At this time, the end divisional portion 10 is located on the end side (upper side of FIG. 8) with respect to the base divisional portion 9 according to the positional relation between the pin 11b and the groove 11c and is in the protruding state.

The electronic device of the second embodiment is basically similar to the electronic device 1 of the first embodiment except for the presence of the interlocking mechanism 11. According to the second embodiment, the same effect as previously described for the first embodiment can be achieved. Besides, according to the second embodiment, the interlocking mechanism 11 slides the end divisional portion 10 relative to the base divisional portion 9 attached to the first body 2 by the movement of the plate 11a as a moving member attached to the second body 3 relative to the first body 2 in response to the relative rotation of the first body 2 and the second body 3 about the rotation axis Ax. Thus, when the user moves the first body 2 and the second body 3 from the closed position to the open position, the end divisional portion 10 of the speaker unit 7 housed in the housing 2a protrudes out of the housing 2a. Similarly, when the user moves the first body 2 and the second body 3 from the open position to the closed position, the end divisional portion 10 of the speaker unit 7 protruding out of the housing 2a is housed in the housing 2a. That is, the need is eliminated of manipulating the speaker unit 7.

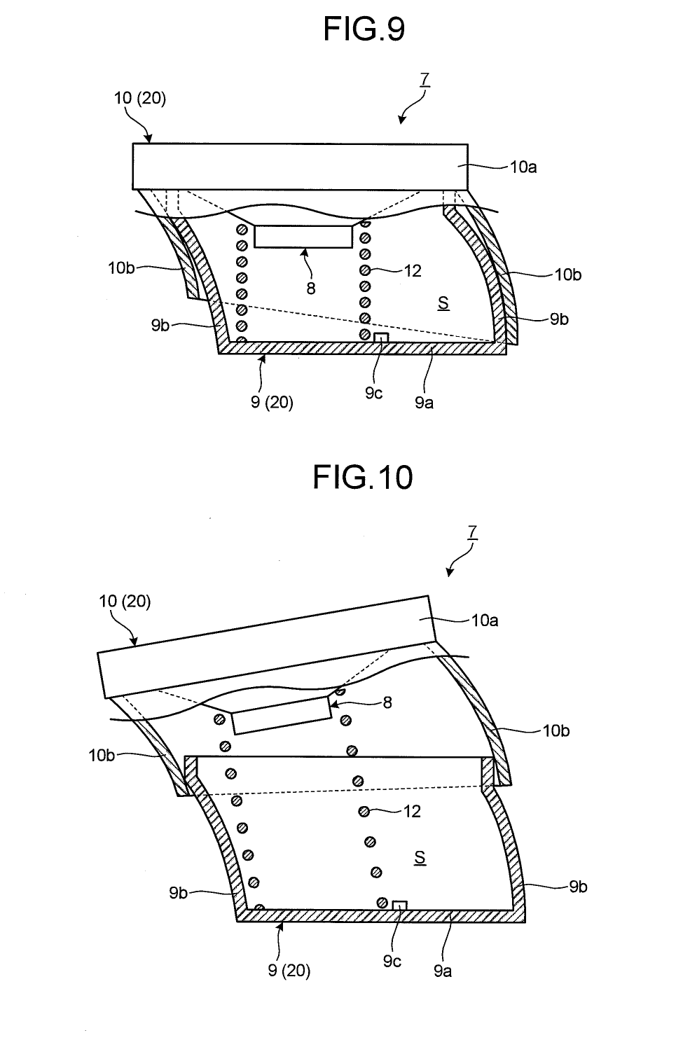

With reference to FIGS. 9 and 10, a description will be given of an electronic device according to a third embodiment.

In the third embodiment, a coil spring 12 is provided as a biasing member to bias the end divisional portion 10 in a direction in which it slides relative to the base divisional portion 9 attached to the first body 2 from the housed state to the protruding state. More specifically, the coil spring 12 is attached between the bottom wall 9a of the base divisional portion 9 and the speaker main body 8 of the end divisional portion 10, and functions as a compression spring. The coil spring 12 biases the base divisional portion 9 and the end divisional portion 10 in a direction in which they separate from each other. In the state where the base divisional portion 9 of the speaker unit 7 is attached to the first body 2, the coil spring 12 biases the end divisional portion 10 in a direction in which it slides relative to the base divisional portion 9 from the housed state to the protruding state. The base divisional portion 9 is provided with a protrusion 9c on the bottom wall 9a to prevent the displacement of the coil spring 12 in a direction along the bottom wall 9a.

With this, according to the third embodiment, when the electronic device is in the closed position, the end divisional portion 10 is pushed by the front surface 3b of the housing 3a of the second body 3 and is in the housed state as illustrated in FIG. 9. On the other hand, when the electronic device is in the open position, the end divisional portion 10 is biased by the coil spring 12 as a biasing member and is in the protruding state as illustrated in FIG. 10. Thus, when the user moves the first body 2 and the second body 3 from the closed position to the open position, the end divisional portion 10 of the speaker unit 7 housed in the housing 2a protrudes out of the housing 2a. Similarly, when the user moves the first body 2 and the second body 3 from the open position to the closed position, the end divisional portion 10 of the speaker unit 7 protruding out of the housing 2a is housed in the housing 2a. That is, according to the third embodiment, the same effect as previously described for the first embodiment can also be achieved, and the need is eliminated of manipulating the speaker unit 7.

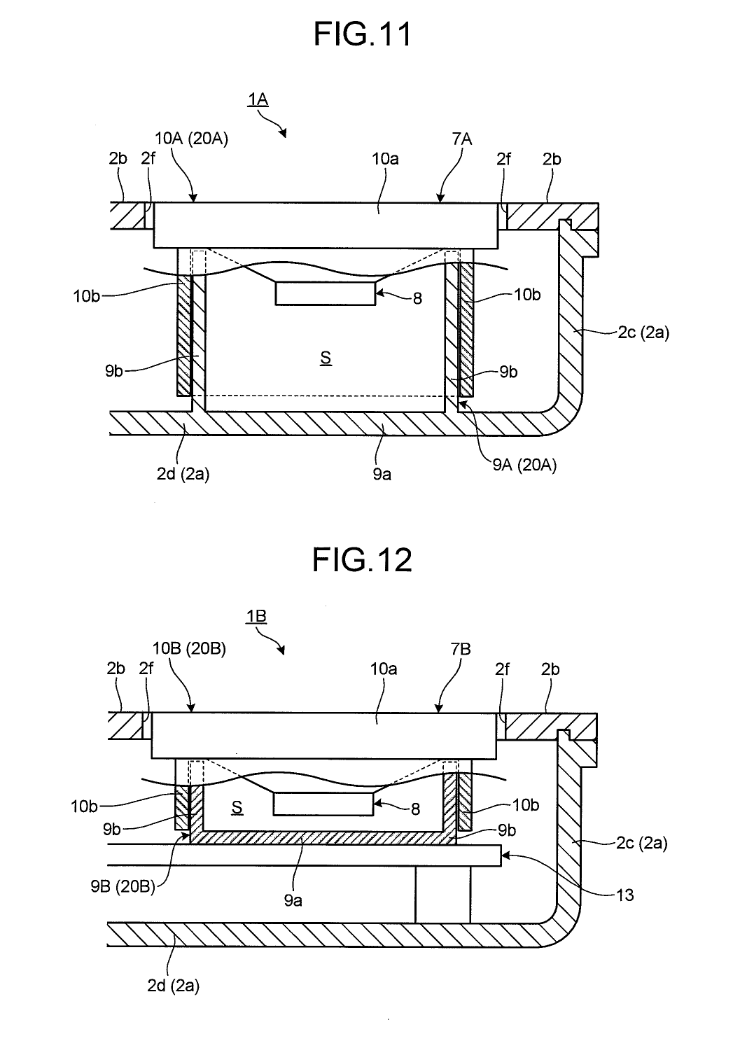

With reference to FIG. 11, a description will be given of an electronic device 1A according to a fourth embodiment.

In the electronic device 1A of the fourth embodiment, part of the housing 2a forms a base divisional portion 9A of a speaker cabinet 20A that constitutes a speaker unit 7A. More specifically, for example, part of a bottom wall 2d near a side wall 2c of the housing 2a of the first body 2 forms the bottom wall 9a of the base divisional portion 9A. The circumference wall 9b of the base divisional portion 9A is provided on the bottom wall 9a. An end divisional portion 10A is located on the end side of the base divisional portion 9A. The base divisional portion 9A and the end divisional portion 10A are coupled with each other to be relatively slidable. The end divisional portion 10A can be in the housed state where it is housed in the housing 2a and in the protruding state where it protrudes out of the housing 2a (above the front surface 2b) through the opening 2f.

Thus, according to the fourth embodiment, the same effect as previously described for the first embodiment can also be achieved. Moreover, since part of the housing 2a forms the base divisional portion 9A, the number of components can be reduced, resulting in less manufacturing processes and lower manufacturing cost.

With reference to FIG. 12, a description will be given of an electronic device 1B according to a fifth embodiment.

In the electronic device 1B of the fifth embodiment, a base divisional portion 9B of a speaker cabinet 20B that constitutes a speaker unit 7B is attached to a circuit board 13 housed in the housing 2a. An end divisional portion 10B is located on the end side of the base divisional portion 9B. The base divisional portion 9B and the end divisional portion 10B are coupled with each other to be relatively slidable. The end divisional portion 10B can be in the housed state where it is housed in the housing 2a and in the protruding state where it protrudes out of the housing 2a (above the front surface 2b) through the opening 2f.

That is, the base divisional portion need not necessarily be directly attached to the housing 2a, and may be attached to a component (for example, the circuit board 13, etc.) in the housing 2a. With this structure, the same effect can be achieved as with the structure that the base divisional portion is attached to the housing 2a. Moreover, since the base divisional portion is attached to the circuit board 13, a harness (not illustrated) connected to the speaker main body 8 can be shortened. Furthermore, it is easier to connect the harness to a circuit on the circuit board 13.

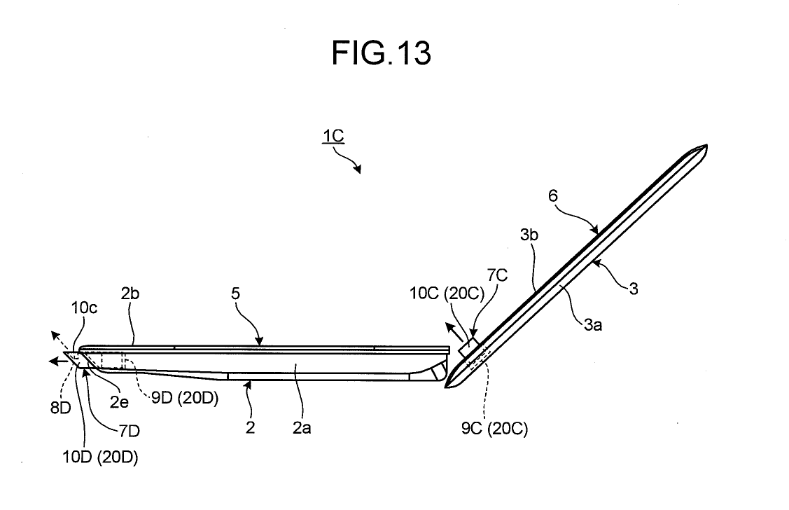

With reference to FIG. 13, a description will be given of an electronic device 1C according to a sixth embodiment.

In the electronic device 1C of the sixth embodiment, speaker units 7C and 7D are each located at a different position from that of the above embodiments. That is, a base divisional portion 9C of a speaker cabinet 20C is provided to the second body 3 on a side close to the first body 2. The base divisional portion 9C may be attached to two points at corners of the second body 3 (corners on a side close to or distant from the first body 2). An end divisional portion 10C of the speaker cabinet 20C may protrude outward from the front surface 3b of the housing 3a of the second body 3 in a direction substantially perpendicular to the front surface 3b.

A base divisional portion 9D of a speaker cabinet 20D is located in the housing 2a of the first body 2 at an edge on the opposite side of the rotation axis Ax with respect to the keyboard 5. An end divisional portion 10D of the speaker cabinet 20D protrudes outward from not the front or bottom surface but a side surface 2e (in the sixth embodiment, a side surface on the opposite side of the rotation axis Ax with respect to the keyboard 5 and on the front side of the electronic device 1C in use viewed from the user) to the front side of the electronic device 1C in use viewed from the user in a direction along the front surface 2b (the horizontal direction in FIG. 13). That is, the speaker unit 7D has a drawer-like structure. A speaker main body 8D is exposed on the front surface 2b side (upper side when the electronic device 1C is placed on a desk or the like) in the protruding state, and outputs sound upward in a direction crossing the front surface 2b.

As described above, the speaker unit 7C may be attached to the second body 3 as in the sixth embodiment. According to the sixth embodiment, the speaker units 7C and 7D are attached to the second body 3 and the first body 2, respectively. Thus, it is easier to attach more speaker units to the electronic device 1C.

The end divisional portion 10D may protrude outward from the side surface 2e of the housing 2a of the first body 2 in a drawer-like manner. Besides, the speaker main body 8D may be attached to a surface (upper surface) of the end divisional portion 10D that is housed in the housing 2a in the housed state and exposed out of the housing 2a in the protruding state. With this, it becomes easier to appropriately set a direction in which the speaker main body 8D outputs sound.

The above embodiments are susceptible to various modifications and alternative forms. For example, the speaker unit may be provided to a position other than that described in the above embodiments. Further, a plurality of speaker units may be provided based on a combination of the above embodiments. Besides, the structure of the divisional portions that are relatively slidable is not limited to what is described in the above embodiments. The speaker cabinet may comprise three or more divisional portions. The divisional portions may slide along a bent path. Still further, the speaker unit with a biasing mechanism may be provided with, for example, a heart cam mechanism between the base divisional portion, the housing, or the circuit board and the end divisional portion for alternate operation in which the speaker unit is housed in the housing and locked when the end divisional portion is pushed into the housing, and is unlocked and protrudes out of the housing when the end divisional portion is pushed again.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic device comprising:
a main body comprising a housing and an electronic component; and
a speaker unit comprising a speaker main body and a speaker cabinet attached to the speaker main body,
wherein the speaker cabinet is configured to be housed in the housing and to protrude out of the housing, and
wherein an inner volume of the speaker cabinet is variable.

2. The electronic device of claim 1, wherein the speaker cabinet comprises a plurality of divisional portions that are connected to each other such that the divisional portions are relatively slidable.

3. The electronic device of claim 2, wherein
the main body comprises a first body comprising a first housing and a second body comprising a second housing,
the first body and the second body are connected by a hinge mechanism such that the first body and the second body are relatively rotatable at least between a closed position where front surfaces of the first housing and the second housing face each other and an open position where the front surfaces are exposed,
the speaker cabinet is housed in the housing when the first body and the second body are in the closed position, and
the speaker cabinet protrudes out of the housing when the first body and the second body are in the open position.

4. The electronic device of claim 3, wherein
the divisional portions comprises a base divisional portion and an end divisional portion attached to the speaker main body, and
the base divisional portion is attached to one of the first body and the second body,
the electronic device further comprising:
a movable member attached to the other one of the first body and the second body; and
an interlocking mechanism configured to slide the end divisional portion relative to the base divisional portion by movement of the movable member relative to the one of the first body and the second body in response to relative rotation of the first body and the second body about a rotation axis of the hinge mechanism.

5. The electronic device of claim 3, wherein
the divisional portions comprises a base divisional portion and an end divisional portion attached to the speaker main body, and
the base divisional portion is attached to one of the first body and the second body,
the electronic device further comprising a biasing member configured to bias the end divisional portion in a direction in which the end divisional portion is configured to slide relative to the base divisional portion from a state where the end divisional portion is housed in the housing to a state where the end divisional portion protrudes out of the housing, and wherein
the speaker cabinet is configured to protrude out of the housing through the biasing member when the first body and the second body are in the open position.

6. The electronic device of claim 3, wherein
the divisional portions comprises an end divisional portion attached to the speaker main body, and
the end divisional portion protrudes outward from a front surface of the first housing or the second housing, when the speaker cabinet protrudes out of the housing.

7. The electronic device of claim 3, wherein
the divisional portions comprises an end divisional portion attached to the speaker main body, and
the end divisional portion protrudes outward from a side surface of the first housing or the second housing, when the speaker cabinet protrudes out of the housing.

8. The electronic device of claim 2, wherein
the divisional portions comprises a base divisional portion attached to the main body, and
a portion of the housing forms the base divisional portion.

9. The electronic device of claim 2, wherein
the divisional portions comprises a base divisional portion attached to the main body, and
the base divisional portion is fixed to a circuit board housed in the housing.

10. The electronic device of claim 2, wherein
the divisional portions comprises a base divisional portion and an end divisional portion attached to the speaker main body,
the base divisional portion is attached to the main body, and
the end divisional portion is configured to slide along a curve relative to the base divisional portion.

11. A speaker unit for an electronic device comprising a main body comprising a housing and an electronic component, the speaker unit comprising:
a speaker main body; and
a speaker cabinet attached to the speaker main body,
wherein the speaker cabinet is configured to be housed in the housing and to protrude out of the housing, and
wherein an inner volume of the speaker cabinet is variable.
